(19) United States
(12) Patent Application Publication
(10) Pub. No.: US 2018/0112988 A1
(43) Pub. Date: Apr. 26, 2018

(54) SYSTEM AND METHOD FOR DISPLAYING POINTS OF INTEREST IN AUGMENTED REALITY

(71) Applicant: XIRO LLC, Woodland Hills, CA (US)

(72) Inventors: Anthony Yukio Woodman, Woodland Hills, CA (US); Jonathon Edward Valker, Huntington Beach, CA (US)

(21) Appl. No.: 15/793,860

(22) Filed: Oct. 25, 2017

Related U.S. Application Data
(60) Provisional application No. 62/412,811, filed on Oct. 25, 2016.

(51) Int. Cl. G01C 21/20; H04W 4/02; G06T 7/70; G06T 19/00

(52) U.S. Cl. CPC G01C 21/206; G06T 19/006; G06T 7/70; H04W 4/02

(57) ABSTRACT

A non-transitory computer-readable storage medium having software instructions stored therein, which, when executed by a processor, cause the processor to transmit a request, from a mobile device having a display and a camera, for points of interest proximate to a current location of the mobile device and receive, at the mobile device, one or more of the points of interest. Each point of interest is associated with geographic coordinates including a latitude, a longitude, and an elevation position. The software instructions also cause the process to capture an image from the camera of the mobile device, overlay the one or more points of interest on the image based on the geographic coordinates, the current location of the mobile device, and an orientation of the camera, and display the image and the one or more points of interest overlaid on the image on the display of the mobile device.

### CROSS-REFERENCE TO RELATED APPLICATION(S)

The present application claims priority to and the benefit of U.S. Provisional Application No. 62/412,811, filed Oct. 25, 2016, the entire contents of which are incorporated herein by reference.

### FIELD

The present disclosure relates generally to systems and methods for displaying points of interest in augmented reality.

### BACKGROUND

Locating points of interest may be difficult and time-consuming in crowded and/or unfamiliar venues. Such points of interest may include fixed or static locations, such as building exits, restrooms, or vendors. The points of interest may also include dynamic locations, such as the locations of individuals moving around a venue. Locating points of interest with conventional maps (either digital or printed) may be cumbersome because they do not typically identify the location and bearing of the user on the map. Additionally, conventional maps are not typically updated frequently, and therefore these maps may not contain event-specific points of interest, such as merchandising booths or food vendors. Furthermore, it may be difficult to locate individuals using conventional maps, particularly if the individual is moving around and/or not located near a landmark identified on the map, such as a particular seating section. Moreover, it may be cumbersome to locate points of interest at venues that do not contain many reference landmarks. For instance, it may be difficult or cumbersome to locate individuals (e.g., friends) at a concert venue, a sporting event, or a crowded beach.

### SUMMARY

The present disclosure is directed to various embodiments of a non-transitory computer-readable storage medium having instructions stored therein for displaying points of interest on a mobile device. In one embodiment, the non-transitory computer-readable storage medium has software instructions stored therein, which, when executed by a processor, cause the processor to transmit a request, from a mobile device having a display and a camera, for points of interest proximate to a current location of the mobile device and receive, at the mobile device, one or more of the points of interest. Each point of interest is associated with geographic coordinates including a latitude, a longitude, and an elevation position. The software instructions also cause the process to capture an image from the camera of the mobile device, overlay the one or more points of interest on the image based on the geographic coordinates, the current location of the mobile device, and an orientation of the camera, and display the image and the one or more points of interest overlaid on the image on the display of the mobile device.

The at least one point of interest may be static or dynamic. The at least one point of interest may include a location of a user of a mobile device. The at least one point of interest may be an exit of a building or a bathroom. Each of the points of interest may be displayed on the display with a visual depiction such as a photograph, a graphic, an animation, a video, or combinations thereof. At least one point of interest may be associated with an emergency.

The present disclosure is also directed to various methods of displaying information on a mobile device having a processor, a non-transitory physical storage medium, a display, and a camera. In one embodiment, the method includes executing, by the processor, instructions stored on the non-transitory physical storage medium, transmitting a request, from the mobile device, for points of interest proximate to a current location of the mobile device, and receiving, at the mobile device, one or more of the points of interest. Each point of interest of the one or more points of interest is associated with geographic coordinates comprising a latitude, a longitude, and an elevation position. The method also includes capturing an image from the camera of the mobile device, overlaying the one or more points of interest on the image based on the geographic coordinates, the current location of the mobile device, and an orientation of the camera, and displaying the image and the one or more points of interest overlaid on the image on the display of the mobile device.

The present disclosure is also directed to various systems for displaying information on a mobile device. In one embodiment, the system includes a camera of the mobile device, a display of the mobile device coupled to the camera, a processor of the mobile device, and a non-transitory computer-readable storage medium of the mobile device coupled to the processor. The non-transitory computer-readable storage medium has software instructions stored therein, which, when executed by the processor, cause the processor to transmit a request, from the mobile device, for points of interest proximate to a current location of the mobile device, and receive, at the mobile device, one or more of the points of interest. Each point of interest of the one or more points of interest is associated with geographic coordinates including a latitude, a longitude, and an elevation position. The instructions, when executed by the processor, further cause the processor to capture an image from the camera of the mobile device, overlay the one or more points of interest on the image based on the geographic coordinates, the current location of the mobile device, and an orientation of the camera, and display the image and the one or more points of interest overlaid on the image on the display of the mobile device.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

The accompanying drawings, together with the specification, illustrate exemplary embodiments of the present disclosure, and, together with the description, serve to explain the principles of the present disclosure.

FIG. 1 is a flowchart depicting various operations of a system and method for displaying points of interest on a mobile device according to one embodiment of the present disclosure;

FIG. 2 is a perspective view of a mobile device operating a software application to locate individuals in a venue according to one embodiment of the present disclosure;

FIG. 3 is a perspective view of a mobile device operating a software application to locate individuals and businesses in a venue according to one embodiment of the present disclosure;

FIG. 4 is a perspective view of a mobile device operating a software application to order and deliver food according to one embodiment of the present disclosure; and

FIG. 5 is a perspective view of a mobile device operating a software application to locate individuals experiencing an emergency according to one embodiment of the present disclosure.

### DETAILED DESCRIPTION

The present disclosure is directed to various systems and methods of visualizing, in real-time, a scene on a mobile electronic device (e.g., a cellular phone, a tablet computer, or a wearable electronic device) and overlaying various points of interest on the scene. In one or more embodiments, the scene may be an image (e.g., a real-time image) captured by a camera of a mobile device (e.g., a cellular phone, a tablet computer, or a wearable electronic device) and the scene with the overlaid point(s) of interest may be displayed on a display of the mobile device. Together, the scene and the overlaid points of interest form an augmented reality scene viewable by a user, which may aid a user in identifying and locating the point(s) of interest.

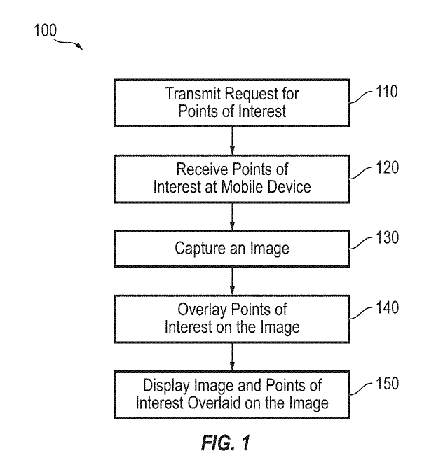

FIG. 1 is a flowchart depicting operation of a system and method 100 for displaying information on a display of a mobile device (e.g., a cellular phone, a tablet computer, or a wearable electronic device) according to one embodiment of the present disclosure. In the illustrated embodiment, the system and method 100 includes an operation 110 of transmitting a request, from the mobile device, for points of interest proximate to a current location (e.g., the GPS coordinates) of the mobile device. The points of interest may include, for example, various event staff (e.g., concert event staff), merchandise locations (e.g., merchandise booths at an event), vendors, security personnel, emergency/medical response personnel, facilities, exits, bathrooms, and/or individuals (e.g., friends and/or family) proximate to the mobile device. The system and method 100 also includes an operation 120 of receiving, at the mobile device, one or more of the points of interest (e.g., from a server or from a second mobile device remote from the mobile device). Each point of interest of the one or more points of interest is associated with geographic coordinates including a latitude, a longitude, and an elevation position. The system and method 100 also includes an operation 130 of capturing an image (e.g., a real-time image) from the camera of the mobile device, and an operation 140 of overlaying the one or more points of interest on the image based on the geographic coordinates associated with the one or more points of interest, the current location of the mobile device, and an orientation of the camera. In the illustrated embodiment, the system and method 100 also includes an operation 150 of displaying the image and the one or more points of interest overlaid on the image on the display of the mobile device.

The above-described operations may be performed by a processor of the mobile device executing software instructions (e.g., a software program) stored on a non-transitory computer-readable storage medium (e.g., computer memory) of the mobile device. When the software instructions are executed by a processor, the instructions cause the processor to transmit a request for points of interest proximate to a current location of the mobile device. These points of interest may include various event staff (e.g., concert event staff), merchandise locations (e.g., merchandise booths at an event), vendors, security personnel, emergency/medical response personnel, facilities, exits, bathrooms, and/or individuals (e.g., friends and/or family). The software instructions also cause the processor to receive one or more points of interest (e.g., from a GPS device, a remote mobile device, or a server). Each point of interest received by the processor is associated with a set of geographic coordinates (e.g., latitude, longitude, and elevation). The software instructions further cause the processor to capture an image from a camera of the mobile device and overlay the one or more points of interest on the image based on the geographic coordinates, the current location of the mobile device, and an orientation of the camera. The software instructions additionally cause the processor to display the image and the one or more points of interest overlaid on the image on the display of the mobile device. Visual depictions of the points of interest may include photographs, graphics, animations, videos, and/or combinations thereof (e.g., a profile picture for points of interest associated with individuals and a logo and/or a trademark for points of interest associated with businesses). In one or more embodiments, the software instructions cause the processor to display visual depictions of the points of interest that include indicia indicating the distance between the mobile device and each of the points of interest.

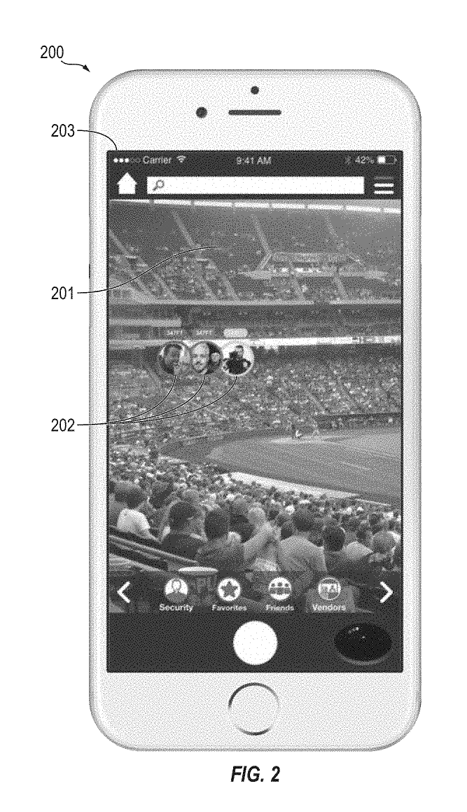

FIG. 2 depicts a mobile electronic device 200 executing, with a processor of the mobile electronic device 200, software instructions stored on a non-transitory computer-readable storage medium of the mobile electronic device 200 to capture a real-time image 201 with a camera of the mobile electronic device 200, and display visual indicia of one or more points of interest 202 (e.g., visual indicia of the locations of one or more individuals, such as friends) overlaid on the image 201 on a display screen 203 of the mobile electronic device 200.

In one or more embodiments, the points of interest 202 may be either pre-programmed geographic locations (e.g., latitude and longitude coordinates) associated with static places such as bathrooms or exits in a building, or the points of interest 202 may be dynamic geographic locations (e.g., the latitude and longitude coordinates obtained from a GPS device) associated with individuals configured to move around and change their location. Additionally, in one or more embodiments, the points of interest 202 may be associated with a GPS device positioned at a static location (e.g., a retail store may be identified as a point of interest based on a GPS device contained in a mobile device of an employee working at that retail store). Based on the current location of the mobile device 200 and the orientation of the camera of the mobile device 200, the points of interest 202 within the field of view of the camera are displayed on the display screen 203 of the mobile device 200 and overlaid on the image 201 captured by the camera. In this manner, a user operating the mobile device 200 may move the camera (e.g., reorient and/or reposition the camera) to easily and readily identify and locate particular points of interest 202 (e.g., to locate individuals within a crowd and/or certain businesses at a large venue). Otherwise, these points of interest may be difficult or prohibitively time-consuming to locate in crowded or large venues, for example.

In one or more embodiments, the points of interest 202 associated with individuals may be limited to particular individuals. For instance, in one or more embodiments, the points of interest 202 may be filtered according to individuals that are members of a particular group or groups (e.g., the points of interest 202 may be filtered to include only those points of interest 202 that are associated with Facebook TM friends). Additionally, in one or more embodiments, users may be able to set permissions to restrict access to their profile and thereby limit those individuals who are able to view the point of interest associated with the physical location of their mobile device.

In one or more embodiments, the points of interest 202 overlaid on the real-time image 201 and displayed on the display 203 of the mobile device 200 may be interactive. For instance, in one or more embodiments in which one of the points of interest 202 is associated with an individual (e.g., a friend), the point of interest 202 may be selected (e.g., by pressing on the portion of the display 203 of the mobile device 200 in which the point of interest 202 is displayed) to enable various additional functionality, such as calling or messaging the individual associated with that point of interest 202. In one or more embodiments in which one of the points of interest 202 is a business (e.g., a retail store), the point of interest 202 may be selected to enable various additional functionality, such as calling or messaging the business associated with point of interest 202, accessing a website associated with that business, and/or accessing menus, exclusive deals, and/or delivery options offered by the business. Accordingly, the additional functionality may vary depending on the type of point of interest 202.

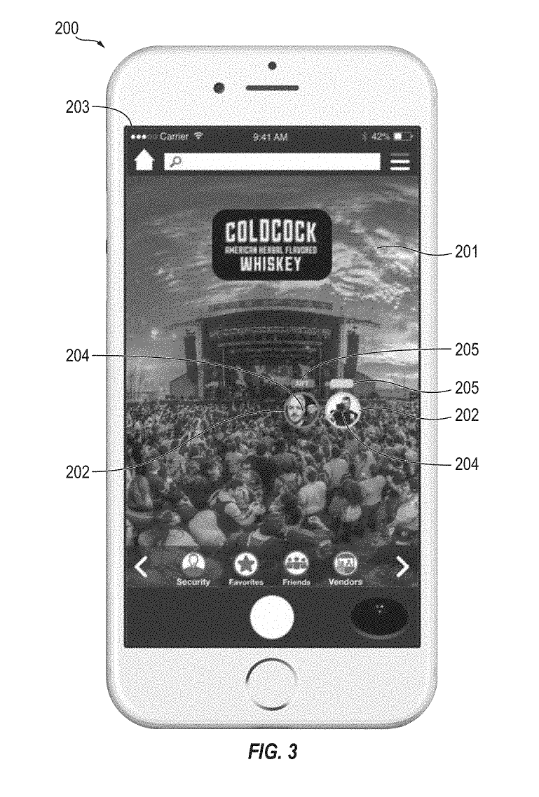

Additionally, the visual representation or depiction of the point of interests 202 on the display 203 of the mobile device 200 may vary depending on the type of point of interest 202. For instance, as illustrated in FIG. 3, the visual representation of a point of interest 202 associated with an individual may include a profile picture 204 of the individual and the visual representation of a point of interest 202 associated with a business may include a logo and/or a trademark associated with the business. In one or more embodiments, the visual representations of the points of interest 202 may include photographs, graphics, animations, videos, and/or combinations thereof. The visual representations of the points of interest 202 may include indicia 205 indicating the distance between the mobile device 200 and each of the points of interest 202.

The points of interest 202 may be limited to a particular geographic area or region proximate to the mobile device 200. For instance, in one or more embodiments, the systems and methods of the present disclosure may filter out points of interest 202 not located within a particular proximity (e.g., approximately 0.5 miles) of the mobile device 200. The proximity within which the points of interest 202 are filtered may be either fixed or adjustable by a user (e.g., the user may increase the proximity at large venues, such as outdoor concerts). Additionally, in one or more embodiments, the points of interest 202 may be filterable by a particular event (e.g., only those points of interest 202 associated with a particular event that the user is attending may be displayed on the display 203 of the mobile device 200).

In one or more embodiments, the points of interested 202 may be filterable based upon one or more keyword terms (e.g., based upon a keyword search). That is, the display 203 of the mobile device 200 may display only those points of interest 202 that match the one or more keyword terms. For example, the term “vegetarian” may be entered as a keyword search term to filter the points of interest 202 such that the display 203 displays only those points of interest 202 associated with vendors offering vegetarian food options.

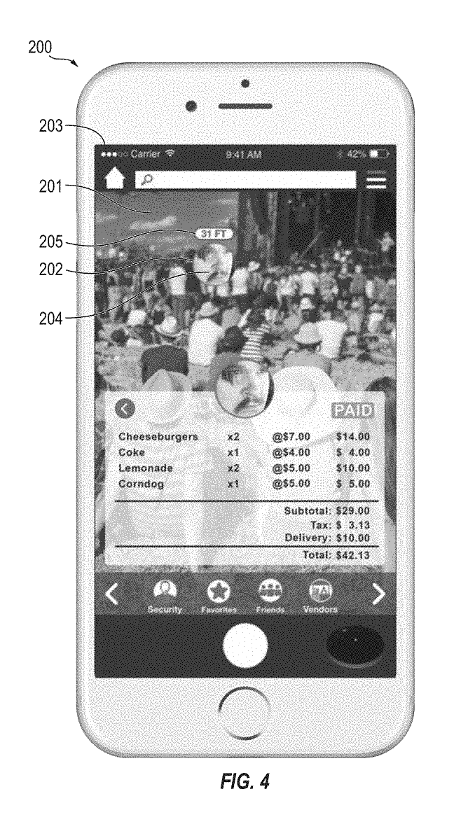

In one or more embodiments, the points of interest 202 may be associated with individuals who have placed an order for the delivery of goods (e.g., food delivery), as illustrated in FIG. 4. In this manner, displaying only the points of interest 202 associated with individuals who placed on order is configured to aid in the expeditious delivery of food or other items to those individuals, particularly if the individuals are located in a crowded and/or large venue, which might otherwise make delivery time-consuming.

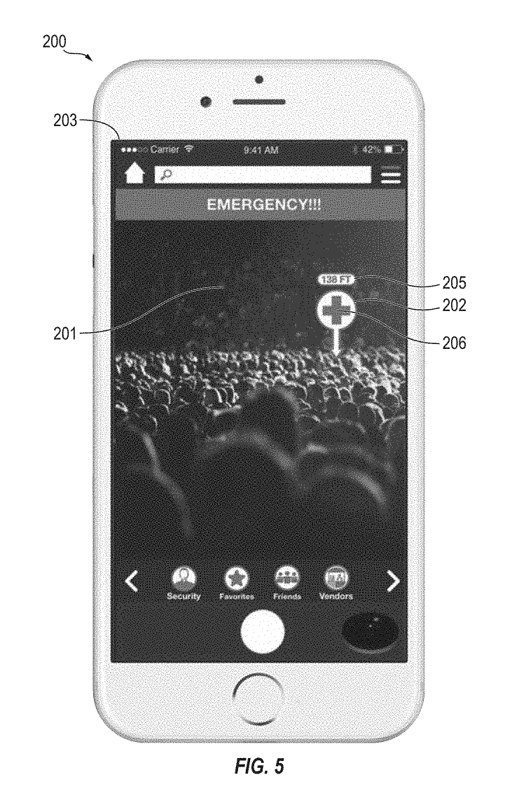

In one or more embodiments, the points of interest 202 may be associated with one or more individuals experiencing an emergency, as illustrated in FIG. 5. The ability to view these emergency points of interest 202 may be restricted to individual devices and/or individual users with certain permissions (e.g., the points of interest 202 associated with emergencies may be viewable only by emergency response personnel, medical personnel, and/or security personnel). In one or more embodiments, the visual representation or depiction of the point of interests 202 associated with an emergency is different than the visual representation or depict of the points of interest 202 associated with non-emergency situations (e.g., the points of interest 202 depicted in FIGS. 2-4). For instance, as illustrated in FIG. 5, points of interest 202 associated with a medical emergency may be depicted with a red cross 206 or other unique indicia indicating that medical attention is required. In addition to the visual depiction of the emergency points of interest, a notification (e.g., a message) may be sent to emergency personnel to alert them of the emergency.

Additionally, in one or more embodiments, the images 201 and the points of interest 202 overlaid on the images 201, which are displayed on the display 203 of the mobile device 200, may be recorded as a video. In one or more embodiments, the video may be uploaded and shared, for example, on various social media platforms.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims, and equivalents thereof.

What is claimed is:

1. A non-transitory computer-readable storage medium having software instructions stored therein, which, when executed by a processor, cause the processor to:
transmit a request, from a mobile device having a display and a camera, for points of interest proximate to a current location of the mobile device;
receive, at the mobile device, one or more of the points of interest, each point of interest of the one or more points of interest being associated with geographic coordinates comprising a latitude, a longitude, and an elevation position;
capture an image from the camera of the mobile device;
overlay the one or more points of interest on the image based on the geographic coordinates, the current location of the mobile device, and an orientation of the camera; and
display the image and the one or more points of interest overlaid on the image on the display of the mobile device.

2. The non-transitory computer-readable storage medium of claim 1, wherein the at least one point of interest is dynamic.

3. The non-transitory computer-readable storage medium of claim 2, wherein the at least one point of interest comprises a location of a user of a mobile device.

4. The non-transitory computer-readable storage medium of claim 1, wherein the at least one point of interest is static.

5. The non-transitory computer-readable storage medium of claim 4, wherein the at least one point of interest is selected from the group consisting of an exit of a building and a bathroom.

6. The non-transitory computer-readable storage medium of claim 1, wherein each of the points of interest is displayed on the display with a visual depiction selected from the group consisting of a photograph, a graphic, an animation, a video, and combinations thereof.

7. The non-transitory computer-readable storage medium of claim 1, wherein the at least one point of interest is associated with an emergency.

8. A method of displaying information on a mobile device having a processor, a non-transitory physical storage medium, a display, and a camera, the method comprising:
executing, by the processor, instructions stored on the non-transitory physical storage medium;
transmitting a request, from the mobile device, for points of interest proximate to a current location of the mobile device;
receiving, at the mobile device, one or more of the points of interest, each point of interest of the one or more points of interest being associated with geographic coordinates comprising a latitude, a longitude, and an elevation position;
capturing an image from the camera of the mobile device;
overlaying the one or more points of interest on the image based on the geographic coordinates, the current location of the mobile device, and an orientation of the camera; and
displaying the image and the one or more points of interest overlaid on the image on the display of the mobile device.

9. The method of claim 8, wherein the at least one point of interest is dynamic.

10. The method of claim 8, wherein the at least one point of interest comprises a location of a user of a second mobile device remote from the mobile device.

11. The method of claim 8, wherein the at least one point of interest is static.

12. The method of claim 11, wherein the at least one point of interest is selected from the group consisting of an exit of a building and a bathroom.

13. The method of claim 8, wherein the displaying the image and the one or more points of interest comprises displaying the one or more points of interest on the display with a visual depiction selected from the group consisting of a photograph, a graphic, an animation, a video, and combinations thereof.

14. The method of claim 8, wherein the at least one point of interest is associated with an emergency.

15. A system for displaying information on a mobile device, the system comprising:
a camera of the mobile device;
a display of the mobile device coupled to the camera;
a processor of the mobile device; and
a non-transitory computer-readable storage medium of the mobile device coupled to the processor, the non-transitory computer-readable storage medium having software instructions stored therein, which, when executed by the processor, cause the processor to:
transmit a request, from the mobile device, for points of interest proximate to a current location of the mobile device;
receive, at the mobile device, one or more of the points of interest, each point of interest of the one or more points of interest being associated with geographic coordinates comprising a latitude, a longitude, and an elevation position;
capture an image from the camera of the mobile device;
overlay the one or more points of interest on the image based on the geographic coordinates, the current location of the mobile device, and an orientation of the camera; and
display the image and the one or more points of interest overlaid on the image on the display of the mobile device.

16. The system of claim 15, wherein the at least one point of interest is static or dynamic.

17. The system of claim 15, wherein the at least one point of interest comprises a location of a user of a mobile device.

18. The system of claim 15, wherein the at least one point of interest is selected from the group consisting of an exit of a building and a bathroom.

19. The system of claim 1, wherein the software instructions, when executed by the processor, cause the processor to display each of the points of interest on the display with a visual depiction selected from the group consisting of a photograph, a graphic, an animation, a video, and combinations thereof.

20. The system of claim 1, wherein the at least one point of interest is associated with an emergency.
